(19) United States
(12) Patent Application Publication
(10) Pub. No.: US 2020/0331245 A1
(43) Pub. Date: Oct. 22, 2020

(54) EXTERIOR PANEL FOR VEHICLES

(71) Applicants: Hyundai Motor Company, Seoul (KR); Kia Motors Corporation, Seoul (KR); Kolon Glotech, Inc., Seoul (KR)

(72) Inventors: Kyeong Bae Seo, Gyeonggi-do (KR); Kyung Min Yu, Seoul (KR); Sang Sun Park, Gyeonggi-do (KR); Jae Kuk Park, Yongin (KR); Sun Yoon, Gyeonggi-do (KR); Woo Jin Jung, Gyeonggi-do (KR); Dong Won Kim, Gyeonggi-do (KR); Hye Ryong Jang, Seoul (KR); Dae Il Lee, Seoul (KR)

(21) Appl. No.: 16/741,237

(22) Filed: Jan. 13, 2020

(30) Foreign Application Priority Data
Apr. 18, 2019 (KR) 10-2019-0045500

(51) Int. Cl. B32B 27/12; B32B 27/32; B32B 3/12; B32B 5/02; B32B 27/08; B32B 27/36

(52) U.S. Cl. CPC B32B 27/12; B32B 27/32; B32B 3/12; B32B 5/02; B32B 27/08; B32B 2260/023; B32B 2605/08; B32B 2262/101; B32B 2262/0269; B32B 2262/0253; B32B 27/36

(57) ABSTRACT

An exterior panel for vehicles is provided and includes a core layer having a predetermined curved surface and skin layers disposed along the curved surface of the core layer. Additionally, mid layers are disposed between the core layer and the skin layers, or are disposed on surfaces of the skin layers.

### CROSS-REFERENCE TO RELATED APPLICATION

This application claims under 35 U.S.C. § 119(a) the benefit of priority to Korean Patent Application No. 10-2019-0045500 filed on Apr. 18, 2019, the entire contents of which are incorporated herein by reference.

### BACKGROUND

### (a) Technical Field

The present disclosure relates to an exterior panel for vehicles, and more particularly, to an exterior vehicle panel that has a curved shape to prevent a core thereof from being visible to the outside.

### (b) Background Art

Generally, exterior panels used as roof panels, doors, bonnets, trunk doors, etc. of vehicles, are formed of steel, and thus have excellent strength but with an increase in weight. The increase in weight may decrease fuel efficiency. Therefore, a technology that reduces the weight of an exterior panel for vehicles has been required.

Accordingly, for weight reduction, an exterior panel has been developed in which a thin plate-type skin layer formed of a composite resin is bonded to the surface of a core layer having a honeycomb structure formed of paper. This type of exterior panel may achieve weight reduction, but it is difficult to manufacture an exterior panel having a curved surface due to characteristics of the exterior panel material, and thus limitations are imposed upon the design thereof. Further, the shape of the core is transferred to the skin layer and is thus visible to the outside, thereby lowering the marketability of the exterior panel.

### SUMMARY

The present invention provides an exterior panel for vehicles which may be freely formed into a shape having a curved surface and prevent the shape of a core located therein from being visible to the outside.

In one aspect, the present invention provides an exterior panel for vehicles that may include a core layer having a predetermined curved surface, skin layers disposed along the curved surface of the core layer, and mid layers disposed between the core layer and the skin layers, or disposed on surfaces of the skin layers, wherein the core layer is formed of a thermoplastic resin. The core layer may be formed of polypropylene (PP). Additionally, the core layer may include one of a honeycomb structure and a plurality of tubes, and the tubes may be connected to each other.

Further, the skin layers may include Continuous Fiber Thermoplastic (CFT). In another exemplary embodiment, the Continuous Fiber Thermoplastic (CFT) may include a first layer having fibers arranged in a first direction, a second layer stacked on the first layer and having fibers arranged in a second direction perpendicular to the first direction, and a resin with which the first layer and the second layer are impregnated.

Additionally, the first layer and the second layer may be repeatedly stacked continuously. Each of the thicknesses of the first layer and the second layer may be about 0.2 mm to 0.3 mm. A thickness of the core layer may be about 10 mm to 20 mm, and a thickness of the skin layers may be about 0.4 mm to 1 mm. The mid layers may include a cast polypropylene (CPP) film. In addition, the exterior panel for vehicles may further include fleece layers disposed between the core layer and the skin layers when the mid layers are disposed on the surfaces of the skin layers.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a schematic view illustrating a vehicle to which an exterior panel for vehicles in accordance with one exemplary embodiment of the present invention is applied;

FIG. 2 is a schematic view illustrating the exterior panel for vehicles applied to a roof of FIG. 1 in accordance with one exemplary embodiment of the present invention;

FIGS. 3A and 3B are plan views illustrating a portion of a core layer of FIG. 2 in accordance with one exemplary embodiment of the present invention;

FIG. 4 is a schematic view illustrating a skin layer of FIG. 2 in accordance with one exemplary embodiment of the present invention; and

FIGS. 5A to 5D are schematic views illustrating a process for manufacturing the exterior panel for vehicles of FIG. 2 in accordance with one exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims. In the following description of the invention, the same or similar elements are denoted by the same reference numerals even though they are depicted in different drawings.

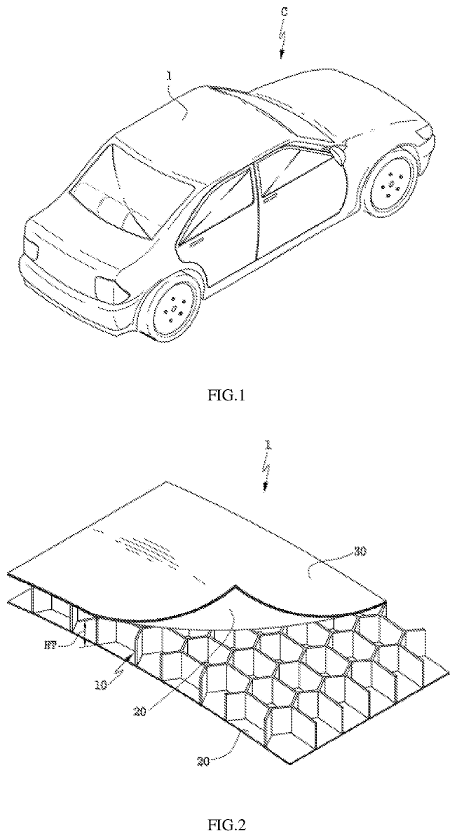

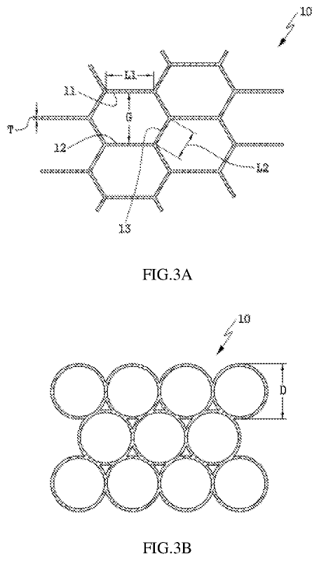

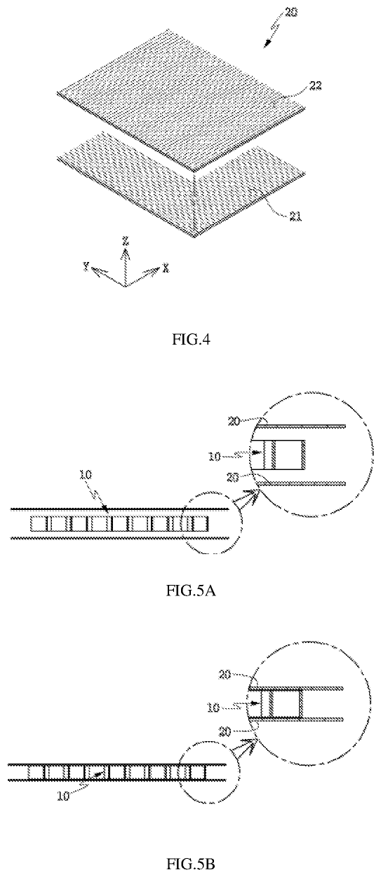

Now, an exterior panel for vehicles in accordance with one exemplary embodiment of the present invention will be described with reference to FIGS. 1 to 4. FIG. 1 is a schematic view illustrating a vehicle to which an exterior panel for vehicles in accordance with one exemplary embodiment of the present invention is applied, FIG. 2 is a schematic view illustrating the exterior panel for vehicles applied to a roof of FIG. 1, FIGS. 3A and 3B are plan views illustrating a portion of a core layer of FIG. 2, and FIG. 4 is a schematic view illustrating a skin layer of FIG. 2.

First, referring to FIGS. 1 and 2, an exterior panel 1 for vehicles in accordance with this exemplary embodiment may include a core layer 10, skin layers 20 and mid layers 30, freely formed into a shape having a curved surface, and that prevent the shape of a core located therein from being visible to the outside. The exterior panel 1 for vehicles in accordance with this exemplary embodiment may form a roof of a vehicle C. However, the exterior panel 1 for vehicles is not limited thereto and may be applied to a door, a bonnet, a trunk door, etc of a vehicle. Further, the exterior panel 1 for vehicles may form an interior floor of a vehicle. The core layer 10 may include a honeycomb structure formed by connecting hexagonal cells. The inside of the honeycomb structure may be vertically hollow.

Referring to FIG. 3A, as the honeycomb structure is seen from the top, a distance G between a first plane 11 and a second plane 12, which are opposite each other and parallel to each other, may be about 3 mm to 11 mm. Particularly, the distance G may be about 9 mm. More particularly, the distance G may be about 3 mm to 5 mm. Further, a length L1 of the first plane 11 and the second plane 12 may be about 5 mm to 9 mm. Preferably, the length L may be about 7 mm. A length L2 of an inclined plane 13 which connects the first plane 11 and the second plane 12 may be about 3.5 mm to 7.5 mm. Particularly, the length L2 may be about 5.5 mm. Further, a thickness T of walls forming the honeycomb structure may be about 0.25 mm to 0.27 mm. The walls of the honeycomb structure may be single walls.

However, the walls of the honeycomb structure may be double walls. In particular, a thickness of the double walls of the honeycomb structure may be about 0.5 mm to 1.5 mm. Particularly, the thickness of the double walls of the honeycomb structure may be about 1 mm. Further, a vertical thickness HT (with reference to FIG. 2) of the honeycomb structure may be about 10 mm to 20 mm. Preferably, the vertical thickness HT of the honeycomb structure may be about 15 mm.

When the vertical thickness HT of the honeycomb structure is less than about 10 mm, the honeycomb structure is light-weight but may be easily damaged by external force. On the other hand, when the vertical thickness HT of the honeycomb structure exceeds about 20 mm, the weight of the honeycomb structure is increased and a weight reduction may not be achieved. Further, an increase in the vertical thickness HT of the honeycomb structure may increase manufacturing costs and deteriorate formability.

Referring to FIG. 3B, the core layer 10 may include tubes having a cylindrical shape and being vertically hollow. In other words, the interior of the cylindrical tube may be hollow. Additionally, a diameter D of the tubes may be about 6 mm to 10 mm. Particularly, the diameter D of the tubes may be about 8 mm. The diameter D of the tubes may be an outer diameter of the tubes. Further, a thickness of walls forming the tubes may be about 0.25 mm. A vertical thickness of the tubes is the same as the vertical thickness of the honeycomb structure.

A plurality of tubes may be connected to each other and neighboring tubes may be connected through fusion, thus not being separated from each other. The honeycomb structure or the tubes forming the core layer 10 are not limited to the above-described standard. The standard of the honeycomb or the tubes may vary based on application fields of the exterior panel for vehicles.

The core layer 10 may be formed of polypropylene (PP), which is a thermostatic resin. The formed core layer 10 may be deformed into a predetermined shape by applying heat thereto. Additionally, the core layer 10 may be formed into a shape having a curved surface or a streamlined shape due to the heat applied thereto. The skin layers 20 may be disposed on both the upper and lower surfaces of the core layer 10. The skin layers 20 may include Continuous Fiber Thermoplastic (CFT). The skin layers 20 supplement heat resistance, solvent resistance and strength of the core layer 10.

Referring further to FIG. 4, the skin layer 20 may include a first layer 21 having fibers arranged in a first direction Y, a second layer 22 stacked on the first layer 21 and having fibers arranged in a second direction X perpendicular to the first direction Y, and a resin with which the first layer 21 and the second layer 22 are impregnated. Particularly, the first layer 21 may include polypropylene, and the second layer 22 may include carbon fiber (CF). However, the first layer 21 and the second layer 22 may be formed of glass fiber (GF), natural fiber (NF), aramid fiber, ultrahigh molecular weight polyethylene (UHMWPE) fiber, etc.

Each of thicknesses of the first layer 21 and the second layer 22 may be about 0.2 mm to 0.3 mm. Particularly, each of the thicknesses of the first layer 21 and the second layer 22 may be about 0.25 mm. The first layer 21 and the second layer 22 may be repeatedly stacked continuously (e.g., continuously stacked in an alternating manner). An overall thickness of the skin layer 20 formed by continuously stacking the first layer 21 and the second layer 22 may be about 0.4 mm to 1 mm. When the overall thickness of the skin layer 20 is less than about 0.4 mm, the skin layer 20 may be damaged by external force.

To form the exterior panel 1 for vehicles, heat of a predetermined temperature may be applied to a structure in which the skin layers 20 are placed on the core layer 10. The heat may be transmitted to the core layer 10 via the skin layers 20. Particularly, when the thickness of the skin layer 20 exceeds about 1 mm, a heat conduction path is elongated, and thus, a heating time increases. Therefore, a forming temperature, a forming time, etc. of the exterior panel 1 for vehicles may vary according to the thickness of the skin layers 20.

This detailed configuration of the skin layers 20 is the same as that of the known Continuous Fiber Thermoplastic (CFT), and a detailed description thereof will thus be omitted. Further, fleece layers (not shown) for increasing adhesive force between the skin layers 20 and the core layer 10 may be disposed between the skin layers 20 and the core layer 10. The resin of the skin layers 20 and the material of the core layer 10 may be melted and permeate the fleece layers, when heat adhesion is performed, thereby improving adhesive force.

The fleece layers may be formed of polyethylene terephthalate (PET). Additionally, the fleece layer may be a non-woven fabric having a weight of about 40 g/m² to 50 g/m². When the weight thereof is less than about 40 g/m², a fleece layer has a low thickness, thus decreasing adhesive force, whereas when the weight thereof is greater than about 50 g/m² a fleece layer has a higher thickness, thus increasing adhesive force as well as cost thereof. The fleece layers may be variously changed according to the material of the core layer 10. In particular, the fleece layers may be formed of polypropylene (PP), nylon, etc.

The mid layers 30 may be disposed on the surfaces of the skin layers 20, and include a cast polypropylene (CPP) film. The mid layers 30 may be bonded to the surfaces of the skin layers 20 by disposing the core layer 10, to which the skin layers 20 are bonded, in a mold device and then injecting polyurethane into the mold device. The mid layers 30 supplement the surfaces of the core layers 10 and cause the shape of the core layer 10 transferred to the skin layers 20 to invisible. However, the mid layers 30 may be disposed between the skin layers 20 and the core layer 10. In this case, the fleece layers may be omitted. The mid layers 30 may be variously changed according to the design of the exterior panel 1 for vehicles.

The thickness of the mid layers 30 may be about 0.5 mm to 2.0 mm. When the thickness of the mid layers 30 is less than about 0.5 mm, the mid layers 30 are incapable of hiding the shape of the core layer 10 transferred to the skin layers 20 and may be easily damaged by external factors, such as scratches, an impact, etc. When the thickness of the mid layers 30 is greater than about 2.0 mm, manufacturing costs may be increased.

The mid layers 30 may use a product which has weather resistance (e.g., water resistant) and is not discolored or damaged when exposed to an external environment for a long period of time. Therefore, coating layers, which may prevent discoloring and deformation of the mid layers 30 and block ultraviolet light, may be further formed on the surfaces of the mid layers 30.

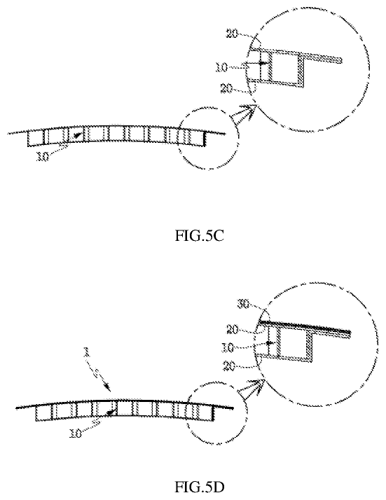

The above-described exterior panel 1 will be formed as follows. Referring to FIGS. 5A-5D, the core layer 10 and the skin layer 20 may be stacked sequentially. The skin layers 20 may be disposed on both the upper and lower surfaces of the core layer 10 to be opposite each other. In particular, the edges of the upper and lower skin layers 20 may exceed that of the core layer 10, thus directly facing each other (in FIG. 5A). Heat of a temperature of about 140° C. to 260° C. may be applied to the core layer 10 and the skin layers 20 which are stacked, through a heating apparatus (in FIG. 5B). Particularly, heat of a temperature of about 160° C. may be applied to the stacked core layer 10 and skin layers 20 for about 100 to 180 seconds.

Polypropylene of the core layer 10 and the skin layers 20 may be melted and flow down to the core layer 10 due to heating. When the temperature of heat applied by the heating apparatus is less than about 140° C., polypropylene of the skin layers 20 may not be effectively melted, and when the temperature of heat applied by the heating apparatus is greater than about 260° C., the skin layers 20 may be melted and thus become a liquid. Further, when the heating time of the core layer 10 and the skin layers 20 is less than about 100 seconds, polypropylene of the skin layers 20 may not be sufficiently melted. Therefore, formability may be reduced.

A pressure of about 0.5 N/cm² to 1.5 N/cm² may be applied to the core layer 10 and the skin layers, which have been stacked and heated, using the mold device. Since the pressurized core layer 10 and skin layers 20 are in a molten state, they are bonded to each other and are thus formed as the exterior panel 1 for vehicles which has a curved surface along the shape of a cavity of the mold device (in FIG. 5C). The edges of the upper and lower skin layers 20 deviating from the core layer 10 may be bonded to each other. Particularly, the cavity may be formed in a lower mold of the mold device. To form the mid layers 30 on the skin layers 20, a cast polypropylene (CPP) film may be stacked on the skin layers 20.

The mid layers 30 and the skin layers 20 may be bonded to each other by performing reaction injection molding (RIM) on a stack of the core layer 10, the skin layers 20 and the mid layers 30 employing the CPP film (in FIG. 5D). In reaction injection molding (RIM), the mid layers 30 and the skin layers 20 may be bonded to each other by injecting polyurethane into the mold device. To increase adhesive force between the mid layers 30 and the skin layers 20, the surfaces of the skin layers 20 and the mid layers 30 may be treated with a primer.

The edges of the upper and lower skin layers 20 may be bonded to each other, and thus, generation of bubbles during reaction injection molding (RIM) may be minimized Therefore, the quality of a product formed through reaction injection molding (RIM) may be improved. Further, the mid layers 30 may be disposed between the skin layers 20 and the core layer 10. In particular, the mid layers 30 may be disposed on the surfaces of the core layer 10, and the skin layers 20 may be disposed on the surfaces of the mid layers 30. The shape of the core layer 10 may be hidden (e.g., covered by) by the mid layers 30 and not transferred to the skin layers 20. Thus, the skin layers 20 have smooth surfaces.

As the mid layers 30 are bonded to the skin layers 20, the shape of the core layer 10 transferred to the skin layers 20 is not exposed to the outside, and the exterior panel 10 for vehicles has a smooth surface thus improving the external appearance. Therefore, the external appearance of a vehicle, to which such an exterior panel 10 for vehicles is applied, may also be increased.

A vehicle in accordance with one exemplary embodiment of the present invention includes an exterior panel for vehicles. The exterior panel for vehicles may have the characteristics described with reference to FIGS. 1 to 5D. Therefore, the exterior panel for vehicles in accordance with this exemplary embodiment is the same as the above-described exterior panel for vehicles with reference to FIGS. 1 to 5D, and a detailed description thereof will thus be omitted.

As is apparent from the above description, in an exterior panel for vehicles in accordance with one exemplary embodiment of the present invention, mid layers may be bonded to skin layers to prevent exposure of the shape of a core layer transferred to the skin layers to the outside, and thus, the aesthetic appearance of the exterior panel for vehicles is increased. Additionally, the aesthetic appearance of a vehicle, to which the exterior panel for vehicles is applied, may be increased.

Further, in the exterior panel for vehicles in accordance with one exemplary embodiment of the present invention, the core layer having a honeycomb structure may be formed of a thermoplastic resin, and thus the core layer may have a free shape (e.g., adjustable, or moldable shape). Therefore, the entirety or the edge of the core layer may have a shape having a curved surface. When the core layer is formed to have a curved surface, the core layer may be prevented from being damaged. Thus, the exterior panel for vehicles may be formed to have various shapes, and may increase design freedom.

In addition, the exterior panel for vehicles in accordance with one exemplary embodiment of the present invention has a honeycomb structure and may include Continuous Fiber Thermoplastic (CFT), and may thus enable weight reduction. Therefore, a vehicle to which the exterior panel for vehicles is applied enables weight reduction, and has high fuel efficiency due to weight reduction. Further, fleece layers may be disposed between the core layer and the skin layers, and when the core layer and the skin layers are bonded, a resin of the skin layers and a material of the core layer melt and permeate the fleece layers. Thereby, adhesive force between the core layer and the skin layers may be improved.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

what is claimed is:

1. An exterior panel for a vehicle, comprising:
a core layer having a predetermined curved surface;
skin layers disposed along the curved surface of the core layer; and
mid layers disposed between the core layer and the skin layers, or disposed on surfaces of the skin layers.

2. The exterior panel for a vehicle of claim 1, wherein the core layer is formed of a thermoplastic resin.

3. The exterior panel of claim 2, wherein the core layer is formed of polypropylene (PP).

4. The exterior panel of claim 1, wherein the core layer includes one of a honeycomb structure and a plurality of tubes, wherein the tubes are connected to each other.

5. The exterior panel of claim 1, wherein the skin layers comprise Continuous Fiber Thermoplastic (CFT).

6. The exterior panel of claim 5, wherein the Continuous Fiber Thermoplastic (CFT) includes:
a first layer having fibers arranged in a first direction;
a second layer stacked on the first layer and having fibers arranged in a second direction perpendicular to the first direction; and
a resin with which the first layer and the second layer are impregnated.

7. The exterior panel of claim 6, wherein the first layer and the second layer are repeatedly stacked continuously.

8. The exterior panel of claim 6, wherein each of thicknesses of the first layer and the second layer is 0.2 mm to 0.3 mm.

9. The exterior panel of claim 1, wherein a thickness of the core layer is about 10 mm to 20 mm, and a thickness of the skin layers is about 0.4 mm to 1 mm.

10. The exterior panel of claim 1, wherein the mid layers comprise a cast polypropylene (CPP) film.

11. The exterior panel of claim 1, further comprising:
fleece layers disposed between the core layer and the skin layers in a state in which the mid layers are disposed on the surfaces of the skin layers.
